(19) United States
(12) Patent Application Publication
(10) Pub. No.: US 2026/0179579 A1
(43) Pub. Date: Jun. 25, 2026

(54) PIXEL CIRCUIT

(71) Applicant: E Ink Holdings Inc., HSINCHU (TW)

(72) Inventors: Wen Yu KUO, HSINCHU (TW); Kuang-Heng LIANG, HSINCHU (TW)

(21) Appl. No.: 19/334,990

(22) Filed: Sep. 22, 2025

(30) Foreign Application Priority Data
Dec. 19, 2024 (TW) 113149751

(51) Int. Cl. G09G 3/34

(52) U.S. Cl. CPC G09G 3/344; G09G 2300/0842; G09G 2320/0214

(57) ABSTRACT

A pixel circuit includes a first transistor, a scan line, a data line, a selection unit, a storage capacitor, and a pixel electrode. The first transistor includes a gate electrode, a source electrode, and a drain electrode. The scan line is electrically connected with the gate electrode of the first transistor. The data line is electrically connected with the source electrode of the first transistor. The selection unit is electrically connected with the drain electrode of the first transistor. A first end of the storage capacitor is electrically connected with the drain electrode of the first transistor and an input node of the selection unit. The pixel electrode is electrically connected with an output node of the selection unit. The selection unit provides a driving voltage to the pixel electrode.

### CROSS - REFERENCE TO RELATED APPLICATION

This application claims priority to Taiwan Application Serial Number 113149751, filed December 19, 2024, which is herein incorporated by reference in its entirety.

### BACKGROUND

### Field of Invention

The present invention relates to a pixel circuit.

### Description of Related Art

The pixels of conventional electrophoretic displays have a leakage current from the electronic ink layer (front plate lamination) attached to the front of the display, which results in a decrease in the voltage of the data being written. In addition, the storage capacitor design value of the electrophoretic display needs to be larger than that of the liquid crystal display or the organic light emitting diode display in order to maintain the written data voltage to avoid crosstalk. Therefore, in order to provide a larger storage capacitor, the size of the active device transistor needs to be increased, thereby increasing the load and layout space of the scan line and the data line. In addition, design specifications such as panel size, resolution, and pixel density are all restricted.

The current leakage path of the electrophoretic display may come from transistor off leakage current, leakage current between the pixel electrode to the front plate lamination, and leakage current generated between adjacent pixel electrodes through the front plate lamination material. In order to meet the high voltage and high refresh rate requirements of electrophoretic display products, pixel circuit design becomes difficult. In view of this, how to provide a pixel circuit that can solve the above problems is still one of the research directions that urgently need to be studied.

### SUMMARY

The invention provides a pixel circuit.

In one embodiment, the pixel circuit includes a first transistor, a scan line, a data line, a selection unit, a storage capacitor, and a pixel electrode. The first transistor includes a gate electrode, a source electrode, and a drain electrode. The scan line is electrically connected with the gate electrode of the first transistor. The data line is electrically connected with the source electrode of the first transistor. The selection unit is electrically connected with the drain electrode of the first transistor. A first end of the storage capacitor is electrically connected with the drain electrode of the first transistor and an input node of the selection unit. The pixel electrode is electrically connected with an output node of the selection unit. The selection unit provides a driving voltage to the pixel electrode.

In one embodiment, the pixel circuit further includes a front plate lamination top electrode forming a front plate lamination capacitor with the pixel electrode.

In one embodiment, the selection unit is an inverter.

In one embodiment, the selection unit is a buffer.

In one embodiment, the selection unit includes a high voltage source and a low voltage source.

In one embodiment, a second end of the storage capacitor is electrically connected with a high voltage source.

In one embodiment, a second end of the storage capacitor is electrically connected with a low voltage source.

In one embodiment, the selection unit includes a plurality of second transistors, and the first transistor and the second transistor have the same polarity.

In one embodiment, the second transistors of the selection unit are N type transistors.

In one embodiment, the second transistors of the selection unit are P type transistors.

In one embodiment, a second end of the storage capacitor is connected to a common voltage.

Another aspect of the present disclosure is a pixel circuit.

In one embodiment, the pixel circuit includes a first transistor, a scan line, a data line, a selection unit, and a storage capacitor. The first transistor includes a gate electrode, a source electrode, and a drain electrode. The scan line is electrically connected with the gate electrode of the first transistor. The data line is electrically connected with the source electrode of the first transistor. The selection unit is electrically connected with the drain electrode of the first transistor. The selection unit includes a plurality of second transistors having the same polarity. A first end of the storage capacitor is electrically connected with the drain electrode of the first transistor and an input node of the selection unit. A second end of the storage capacitor is electrically connected with a high voltage source or a low voltage source.

In one embodiment, the pixel circuit includes a pixel electrode electrically connected with an output node of the selection unit, and wherein the selection unit provides a driving voltage to the pixel electrode.

In one embodiment, the pixel circuit includes a front plate lamination top electrode forming a front plate lamination capacitor with the pixel electrode.

In one embodiment, the first transistor and the second transistors have the same polarity.

In one embodiment, the selection unit is an inverter.

In one embodiment, the selection unit is a buffer.

In one embodiment, the selection unit connects with the high voltage source and the low voltage source.

In one embodiment, the second transistors of the selection unit are N type transistors.

In one embodiment, the second transistors of the selection unit are P type transistors.

In the aforementioned embodiments, through setting the selection unit between the front plate lamination top electrode and the storage capacitor, the dielectric layer contained in the selection unit can increase the insulation capacity. In this way, the storage capacitor is prevented from being affected by the leakage current generated between the front plate lamination top electrode and the pixel electrodes, and the capacitance value of the storage capacitor can be preferably maintained. The capacitance value of the storage capacitor can be designed as a smaller value, such that the speed of writing data into the storage capacitor is increased. As such, the critical dimension of the first transistor can be reduced, and the load and layout space of the scan line and the data line can be reduced. The second end of the storage capacitor can be connected to the high voltage source Vdd or the low voltage source Vss, and the positive and negative charges of the storage capacitor can determine the voltage outputted by the output node of the selection unit. The high voltage source and the low voltage source connected to the selection unit can stably drive the front plate lamination. Such configuration can replace the traditional method of connecting the second end of the storage capacitor to the common electrode and driving the front plate lamination by the positive and negative voltages of the storage capacitor, which results in disadvantages such as reduced data voltage and increased capacitance design value.

### BRIEF DESCRIPTION OF THE DRAWINGS

The invention can be more fully understood by reading the following detailed description of the embodiment, with reference made to the accompanying drawings as follows:

FIG. 1 is a schematic of a pixel circuit of a display device of one embodiment of the present embodiment.

FIG. 2 is a schematic of a pixel circuit of a display device of one embodiment of the present embodiment.

FIG. 3 is a schematic of a pixel circuit of a display device of one embodiment of the present embodiment.

FIG. 4 is a schematic of a pixel circuit of a display device of one embodiment of the present embodiment.

FIG. 5 is a schematic of a pixel circuit of a display device of one embodiment of the present embodiment.

FIG. 6 is a schematic of a pixel circuit of a display device of one embodiment of the present embodiment.

FIG. 7 is a schematic of a pixel circuit of a display device of one embodiment of the present embodiment.

FIG. 8 is a schematic of a pixel circuit of a display device of one embodiment of the present embodiment.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

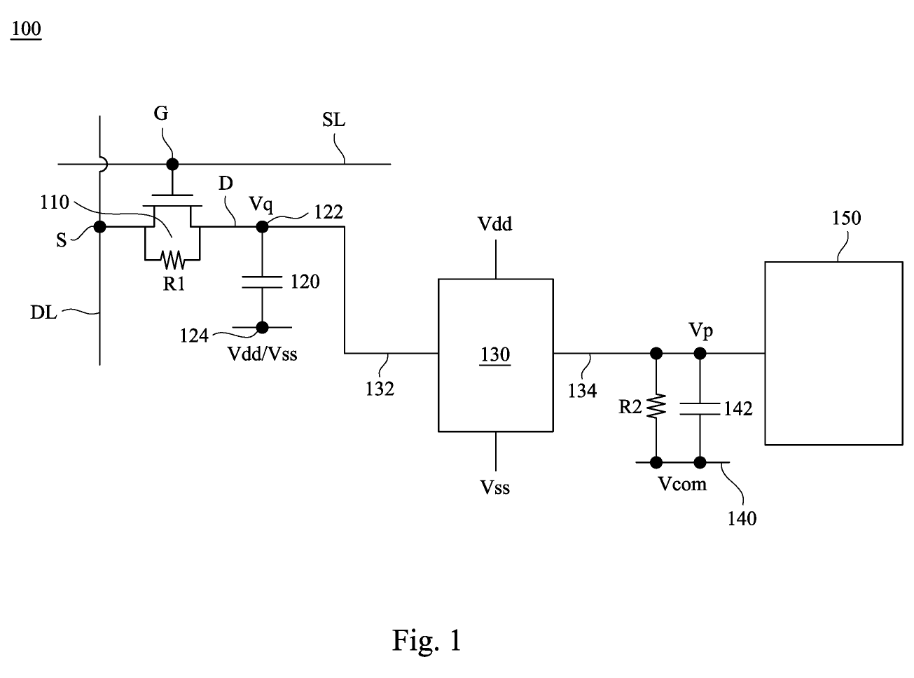

FIG. 1 is a schematic of a pixel circuit 100 of a display device of one embodiment of the present embodiment. The display device can be an electrophoresis display device. The pixel circuit 100 includes a first transistor 110, a scan line SL, a data line DL, a storage capacitor 120, a selection unit 130, a front plate lamination top electrode 140, and a pixel electrode 150. The first transistor 110 includes a gate electrode G, a source electrode S, and a drain electrode D. The scan line SL is electrically connected with the gate electrode G of the first transistor 110. The data line DL is electrically connected with the source electrode S of the first transistor 110. The storage capacitor 120 includes a first end 122 and a second end 124. The selection unit 130 includes an input node 132 and an output node 134. The transistor of the present disclosure can include alpha-silicon, Indium gallium zinc oxide (IGZO), organic, low-temperature polysilicon (LTPS) and other types of thin-film transistors, but this disclosure is not limited thereto. The front plate lamination top electrode 140 is connected to a common voltage Vcom.

The first end 122 of the storage capacitor 120 is electrically connected to the drain electrode D of the first transistor 110 and the input node 132 of the selection unit 130. The selection unit 130 is electrically connected to the drain electrode D of the first transistor 110. The front plate lamination top electrode 140 and the pixel electrode 150 form the front plate lamination capacitor 142. The pixel electrode 150 is electrically connected to the output node 134 of the selection unit 130. The selection unit 130 is configured to provide a driving voltage Vp to the pixel electrode 150, so that a cross-voltage between the driving voltage Vp and the common voltage Vcom connected to the front plate lamination top electrode 140 forms the front plate lamination capacitor 142.

The first transistor 110 will produce an off leakage current, which is selection represented by the first resistance R1. A leakage current is generated between the front plate lamination top electrode 140 and the pixel electrodes 150, which is denoted by the second resistor R2. By setting the selection unit 130 between the front plate lamination top electrode 140 and the storage capacitor 120, the dielectric layer contained in the selection unit 130 can increase the insulation capacity. In this way, the storage capacitor 120 is prevented from being affected by the leakage current generated between the front plate lamination top electrode 140 and the pixel electrodes 150, and the capacitance value of the storage capacitor 120 can be preferably maintained.

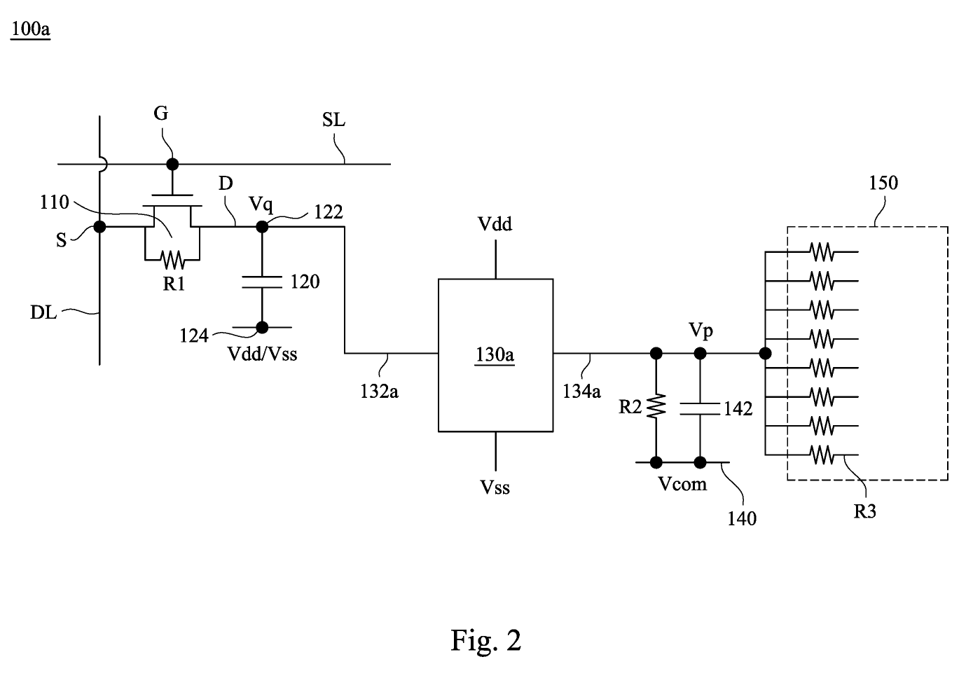

FIG. 2 is a schematic diagram of a pixel circuit 100a of a display according to one embodiment of the present disclosure. A leakage current is generated between adjacent pixel electrodes 150 in the pixel circuit 100 through the front plate lamination material, and is represented by the third resistor R3. As described above, by disposing the selection unit 130 between the pixel electrode 150 and the storage capacitor 120, the insulation capability can be increased by the dielectric layer contained in the selection unit 130. As such, the storage capacitor 120 can be prevented from being affected by the leakage current generated between the pixel electrodes 150 through the front plate lamination material, and the capacitance value of the storage capacitor 120 can be better maintained.

In the above embodiments, the capacitance value of the storage capacitor 120 can be designed as a smaller value, such that the speed of writing data into the storage capacitor 120 is increased. As such, the critical dimension of the first transistor 110 can be reduced, and the load and layout space of the scan line SL and the data line DL can be reduced.

In the above embodiment, the second end 124 of the storage capacitor 120 can be connected to the high voltage source Vdd or the low voltage source Vss, and the positive and negative charges of the storage capacitor 120 can determine the voltage output by the output node 134 of the selection unit 130. The high voltage source Vdd and the low voltage source Vss connected to the selection unit 130 can stably drive the front plate lamination. Such configuration can replace the conventional method of connecting the second end 124 of the storage capacitor 120 to the common voltage Vcom and driving the front plate lamination top electrode 140 by the positive and negative voltages of the storage capacitor 120, which results in disadvantages such as reduced data voltage and increased capacitance design value.

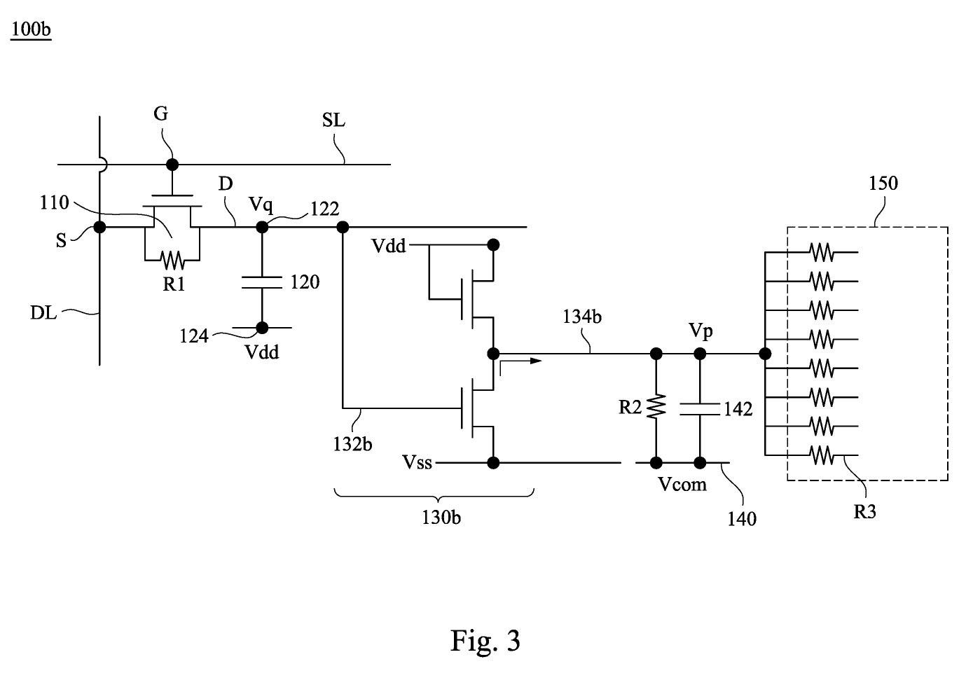

FIG. 3 is a schematic diagram of a pixel circuit 100b of a display according to one embodiment of the present disclosure. In this embodiment, the selection unit 130b is an inverter. The first transistor 110 is an N-type transistor. The inverter includes a second N-type transistor. When the selection unit 130b is an inverter, the polarity of the data voltage Vq written into the storage capacitor 120 is opposite to the polarity of the voltage across the front plate lamination capacitor 142. For example, through writing a data voltage Vq as a positive voltage, the N-type transistor switch connected to the low voltage source Vss in the inverter is turned on, so that the driving voltage Vp applied to the pixel electrode 150 is a negative voltage. The pixel circuit 100b has the same technical advantages as the pixel circuit 100 mentioned above, and therefore the description will not be repeated hereinafter.

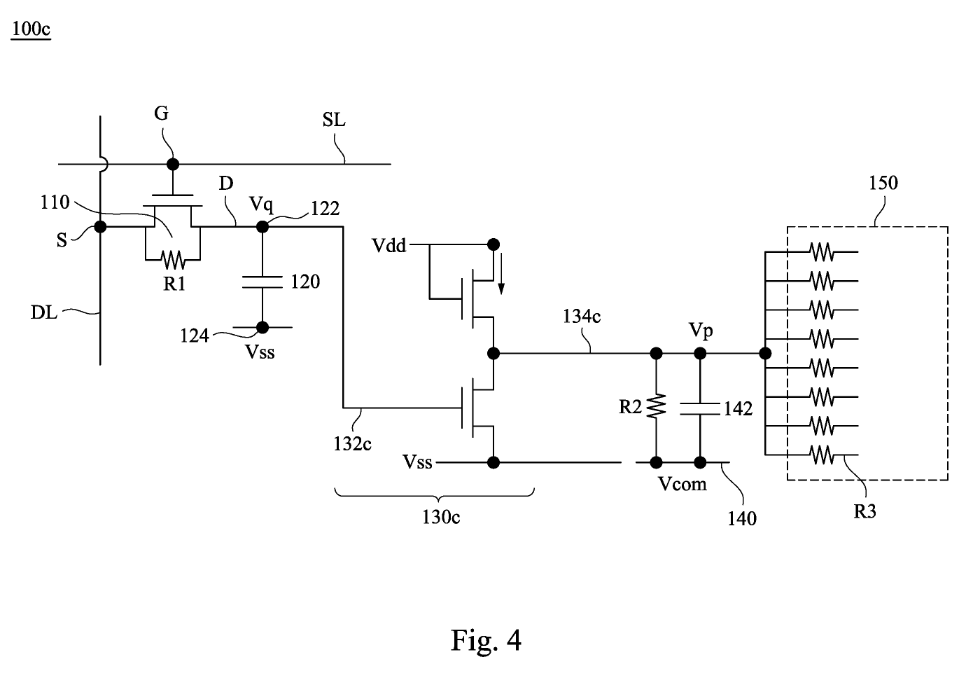

FIG. 4 is a schematic diagram of a pixel circuit 100c of a display according to another embodiment of the present disclosure. The difference between the pixel circuit 100c and the pixel circuit 100b is that the data voltage Vq written into the storage capacitor 120 is a negative voltage. The N-type transistor switch connected to the high voltage source Vdd in the selection unit 130c is turned on, so that the driving voltage Vp applied to the pixel electrode 150 is a positive voltage. The pixel circuit 100c has the same technical advantages as the pixel circuit 100 mentioned above, and therefore the description will not be repeated hereinafter.

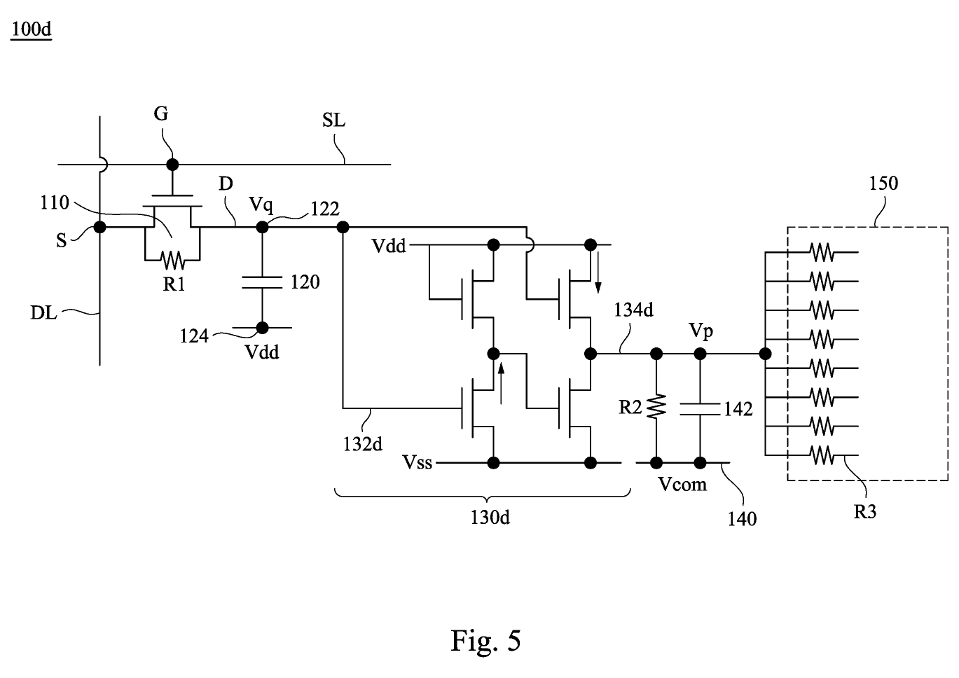

FIG. 5 is a schematic diagram of a pixel circuit 100d of a display according to an embodiment of the present disclosure. In this embodiment, the selection unit 130d is a buffer and includes four N-type transistors. When the selection unit 130d is a buffer, the polarity of the data voltage Vq written into the storage capacitor 120 is the same as the polarity of the voltage across the front plate lamination capacitor 142. For example, through writing a data voltage Vq as a positive voltage, an N-type transistor switch connected to a low voltage source Vss in the buffer is turned on to generate a negative voltage, and then another N-type transistor switch connected to a high voltage source Vdd is turned on, so that the driving voltage Vp applied to the pixel electrode 150 is a positive voltage. The pixel circuit 100d has the same technical advantages as the pixel circuit 100 mentioned above, and therefore the description will not be repeated hereinafter.

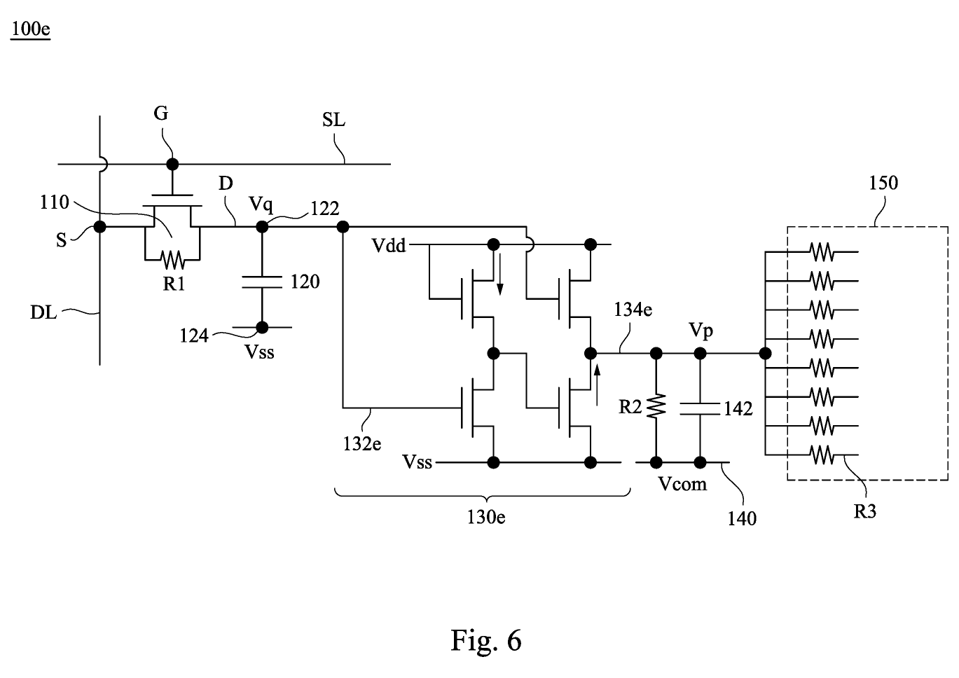

FIG. 6 is a schematic diagram of a pixel circuit 100e of a display according to one embodiment of the present disclosure. The difference between the pixel circuit 100e and the pixel circuit 100d is that the data voltage Vq written into the storage capacitor 120 is a negative voltage. The N-type transistor switch connected to the high voltage source Vdd in the selection unit 130e is turned on to generate a positive voltage, and then another N-type transistor switch connected to the low voltage source Vss is turned on, so that the driving voltage Vp applied to the pixel electrode 150 is a negative voltage. The pixel circuit 100e has the same technical advantages as the pixel circuit 100 mentioned above, and therefore the description will not be repeated hereinafter.

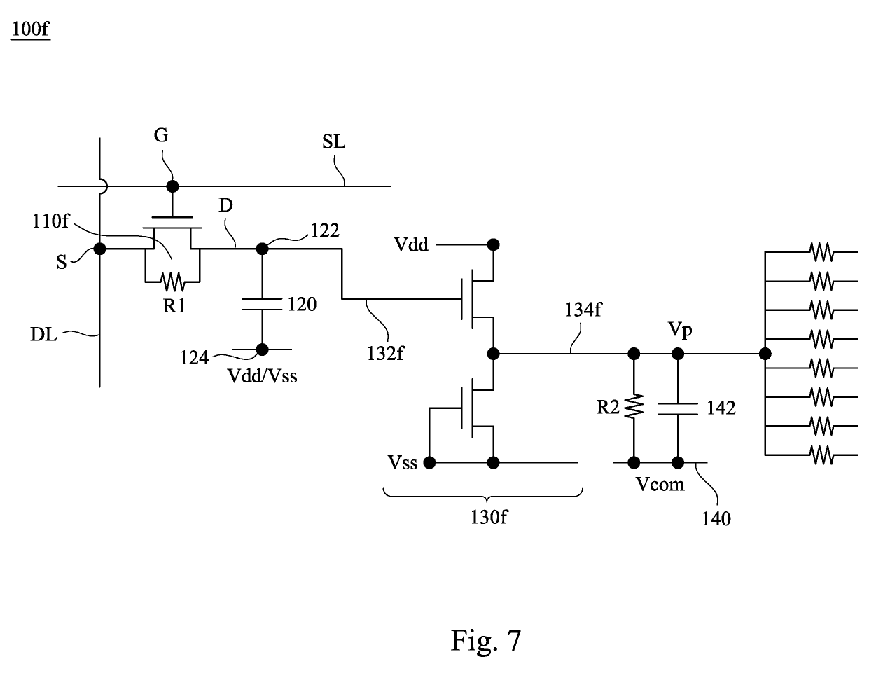

FIG. 7 is a schematic diagram of a pixel circuit 100f of a display according to one embodiment of the present disclosure. In this embodiment, the first transistor 110f is a P-type transistor. The selection unit 130f is an inverter and includes a P-type transistor. When the selection unit 130f is an inverter, the polarity of the data voltage Vq written into the storage capacitor 120 is opposite to the polarity of the voltage across the front plate lamination capacitor 142. The pixel circuit 100f has the same technical advantages as the pixel circuit 100 mentioned above, and therefore the description will not be repeated hereinafter.

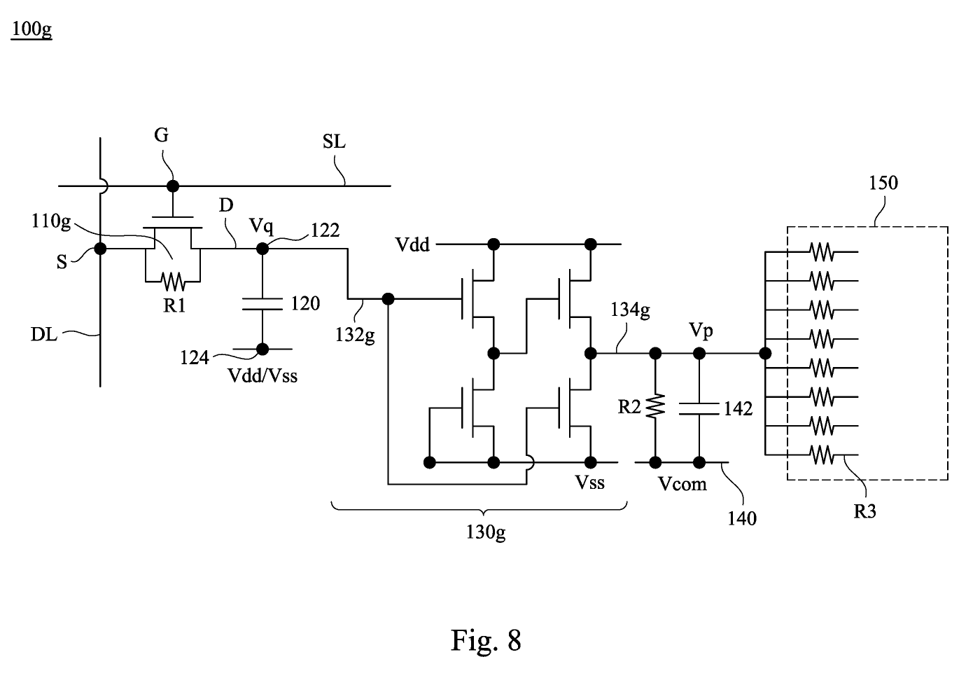

FIG. 8 is a schematic diagram of a pixel circuit 100g of a display according to one embodiment of the present disclosure. In this embodiment, the first transistor 110g is a P-type transistor. The selection unit 130g is a buffer and includes a P-type transistor. When the selection unit 130g is a buffer, the polarity of the data voltage Vq written into the storage capacitor 120 is the same as the polarity of the voltage across the front plate lamination capacitor 142.

In summary, through setting the selection unit 130 between the front plate lamination top electrode and the storage capacitor, the dielectric layer contained in the selection unit can increase the insulation capacity. In this way, the storage capacitor is prevented from being affected by the leakage current generated between the front plate lamination top electrode and the pixel electrodes, and the capacitance value of the storage capacitor can be preferably maintained. The capacitance value of the storage capacitor can be designed as a smaller value, such that the speed of writing data into the storage capacitor is increased. As such, the critical dimension of the first transistor can be reduced, and the load and layout space of the scan line and the data line can be reduced. The second end of the storage capacitor can be connected to the high voltage source Vdd or the low voltage source Vss, and the positive and negative charges of the storage capacitor can determine the voltage outputted by the output node of the selection unit. The high voltage source and the low voltage source connected to the selection unit can stably drive the front plate lamination. Such configuration can replace the traditional method of connecting the second end of the storage capacitor to the common electrode and driving the front plate lamination by the positive and negative voltages of the storage capacitor, which results in disadvantages such as reduced data voltage and increased capacitance design value.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A pixel circuit, comprising:
a first transistor comprising a gate electrode, a source electrode, and a drain electrode;
a scan line electrically connected with the gate electrode of the first transistor;
a data line electrically connected with the source electrode of the first transistor;
a selection unit electrically connected with the drain electrode of the first transistor;
a storage capacitor, wherein a first end of the storage capacitor is electrically connected with the drain electrode of the first transistor and an input node of the selection unit; and
a pixel electrode electrically connected with an output node of the selection unit, and wherein the selection unit provides a driving voltage to the pixel electrode.

2. The pixel circuit of claim 1, further comprising:
a front plate lamination top electrode forming a front plate lamination capacitor with the pixel electrode.

3. The pixel circuit of claim 1, wherein the selection unit is an inverter.

4. The pixel circuit of claim 1, wherein the selection unit is a buffer.

5. The pixel circuit of claim 1, wherein the selection unit includes a high voltage source and a low voltage source.

6. The pixel circuit of claim 1, wherein a second end of the storage capacitor is electrically connected with a high voltage source.

7. The pixel circuit of claim 1, wherein a second end of the storage capacitor is electrically connected with a low voltage source.

8. The pixel circuit of claim 1, wherein the selection unit includes a plurality of second transistors, and the first transistor and the plurality of second transistors have the same polarity.

9. The pixel circuit of claim 8, wherein the plurality of second transistors of the selection unit are N type transistors.

10. The pixel circuit of claim 8, wherein the plurality of second transistors of the selection unit are P type transistors.

11. The pixel circuit of claim 1, wherein a second end of the storage capacitor is connected to a common voltage.

12. A pixel circuit, comprising:
a first transistor comprising a gate electrode, a source electrode, and a drain electrode;
a scan line electrically connected with the gate electrode of the first transistor;
a data line electrically connected with the source electrode of the first transistor;
a selection unit electrically connected with the drain electrode of the first transistor, wherein the selection unit includes a plurality of second transistors having the same polarity; and
a storage capacitor, wherein a first end of the storage capacitor is electrically connected with the drain electrode of the first transistor and an input node of the selection unit, and a second end of the storage capacitor is electrically connected with a high voltage source or a low voltage source.

13. The pixel circuit of claim 12, further comprising:
a pixel electrode electrically connected with an output node of the selection unit, and wherein the selection unit provides a driving voltage to the pixel electrode.

14. The pixel circuit of claim 13, further comprising:
a front plate lamination top electrode forming a front plate lamination capacitor with the pixel electrode.

15. The pixel circuit of claim 12, wherein the first transistor and the plurality of second transistors have the same polarity.

16. The pixel circuit of claim 12, wherein the selection unit is an inverter.

17. The pixel circuit of claim 12, wherein the selection unit is a buffer.

18. The pixel circuit of claim 12, wherein the selection unit connects with the high voltage source and the low voltage source.

19. The pixel circuit of claim 12, wherein the plurality of second transistors of the selection unit are N type transistors.

20. The pixel circuit of claim 12, wherein the plurality of second transistors of the selection unit are P type transistors.
